(19) United States
(12) Patent Application Publication
(10) Pub. No.: US 2026/0155410 A1
(43) Pub. Date: Jun. 4, 2026

(54) FUEL CELL SYSTEM

(71) Applicant: TOYOTA JIDOSHA KABUSHIKI KAISHA, Toyota-shi (JP)

(72) Inventors: Seiichi TANAKA, Nagoya-shi (JP); Tsuyoshi MARUO, Okazaki-shi (JP); Hiroyuki SUGANUMA, Aichi-ken (JP); Kazunori ITO, Nagoya-shi (JP)

(21) Appl. No.: 19/368,332

(22) Filed: Oct. 24, 2025

(30) Foreign Application Priority Data
Nov. 29, 2024 (JP) 2024-208607

(51) Int. Cl. H01M 8/04746; H01M 8/0432; H01M 8/04537

(52) U.S. Cl. CPC H01M 8/04753; H01M 8/0432; H01M 8/04582

(57) ABSTRACT

A fuel cell system may include: a fuel cell; a fuel tank; a fuel gas supply path including a linear solenoid valve and an ejector; and a controller configured to supply the fuel gas to the ejector at a target flow rate by controlling operation of the linear solenoid valve. The controller may be configured to execute a linear control mode and a pulse control mode selectively. In the linear control mode, the controller may be configured to achieve the target flow rate by maintaining a constant opening degree of the linear solenoid valve. In the pulse control mode, the controller may be configured to achieve the target flow rate by periodically changing the opening degree of the linear solenoid valve between at least two values.

### CROSS REFERENCE TO RELATED APPLICATION

This application claims priority from Japanese Patent Application No. 2024-208607 filed on Nov. 29, 2024. The entire content of the priority application is incorporated herein by reference.

### TECHNICAL FIELD

The art disclosed herein relates to a fuel cell system.

### BACKGROUND

A fuel cell system is disclosed in Japanese Patent Application Publication No. 2024-012922. This fuel cell system includes a fuel cell, a fuel tank configured to store fuel gas to be supplied to the fuel cell, a linear solenoid valve and an ejector disposed downstream thereof, a fuel gas supply path configured to supply fuel gas from the fuel tank to the fuel cell, and a controller for supplying a target flow rate of fuel gas to the ejector by controlling the operation of the linear solenoid valve. The controller is configured to maintain the opening degree of the linear solenoid valve at a constant value to achieve the target flow rate.

### SUMMARY

In the fuel cell system described in Japanese Patent Application Publication No. 2024-012922, fuel gas is supplied from the fuel tank to the ejector, and a portion of the exhaust gas emitted from the fuel cell is supplied to the ejector. That is, within the ejector, the fuel gas supplied from the fuel tank to the ejector and a portion of the exhaust gas emitted from the fuel cell are mixed. The temperature of the fuel gas contained in the exhaust gas is relatively high. Therefore, when the temperature of the fuel gas supplied from the fuel tank to the ejector is relatively low, the mixing of high-temperature fuel gas and low-temperature fuel gas may cause ice to form. This ice adheres to the nozzle of the ejector. As a result, there is a risk that the supply of fuel gas to the ejector may fall below the target flow rate.

The technology disclosed herein provides a technique which allows to ensure the flow rate of fuel gas supplied to an ejector in a fuel cell system.

In the first aspect of the present technology, a fuel cell system is disclosed. The fuel cell system may comprise: a fuel cell; a fuel tank configured to store fuel gas to be supplied to the fuel cell; a fuel gas supply path comprising a linear solenoid valve and an ejector disposed downstream of the linear solenoid valve, the fuel gas supply path being configured to supply the fuel gas from the fuel tank to the fuel cell; and a controller configured to supply the fuel gas to the ejector at a target flow rate by controlling operation of the linear solenoid valve. The controller may be configured to execute a linear control mode and a pulse control mode selectively. In the linear control mode, the controller is configured to achieve the target flow rate by maintaining a constant opening degree of the linear solenoid valve. In the pulse control mode, the controller is configured to achieve the target flow rate by periodically changing the opening degree of the linear solenoid valve between at least two values.

According to the above configuration, when the controller executes the pulse control mode, ice adhering to the nozzle can be blown off. As a result, the flow rate of fuel gas supplied to the ejector can be ensured in the fuel cell system.

### BRIEF DESCRIPTION OF DRAWINGS

FIG. 1 is a schematic diagram of a fuel cell system.

FIG. 2 is a diagram showing an outline of an ejector.

FIG. 3 is a flowchart showing an LSV control process executed by a controller.

FIG. 4 is a diagram showing a time chart of FC current values, etc., in an LSV linear control.

FIG. 5 is a diagram showing a time chart of FC current values, etc., in a LSV pulse control.

FIG. 6 is a diagram showing a time chart of FC current values, etc. in LSV pulse control according to the second embodiment.

### DETAILED DESCRIPTION

In the first aspect of the present technology, a fuel cell system is disclosed. The fuel cell system may comprise: a fuel cell; a fuel tank configured to store fuel gas to be supplied to the fuel cell; a fuel gas supply path comprising a linear solenoid valve and an ejector disposed downstream of the linear solenoid valve, the fuel gas supply path being configured to supply the fuel gas from the fuel tank to the fuel cell; and a controller configured to supply the fuel gas to the ejector at a target flow rate by controlling operation of the linear solenoid valve. The controller may be configured to execute a linear control mode and a pulse control mode selectively. In the linear control mode, the controller is configured to achieve the target flow rate by maintaining a constant opening degree of the linear solenoid valve. In the pulse control mode, the controller is configured to achieve the target flow rate by periodically changing the opening degree of the linear solenoid valve between at least two values.

According to the above configuration, when the controller executes the pulse control mode, ice adhering to the nozzle can be blown off. Therefore, in the fuel cell system, the flow rate of the fuel gas supplied to the ejector can be ensured.

In a second aspect, in the first aspect, in the pulse control mode, the opening degree of the linear solenoid valve may be periodically changed between the at least two values that are not zero.

When the opening degree of the linear solenoid valve is periodically changed between at least two values including zero, the valve body of the linear solenoid valve seats on the valve seat of the solenoid valve each time the opening degree of the linear solenoid valve becomes zero. According to the above configuration, in the pulse control mode, the valve body does not seat on the valve seat. Therefore, the durability of the linear solenoid valve can be improved.

In a third aspect, in the first or second aspect, the controller may be configured to execute the pulse control mode when a first predetermined condition is satisfied. The first predetermined condition may include, at least, that an outside temperature is less than a predetermined temperature.

When the outside temperature is below a predetermined temperature, the temperature of the fuel gas in the fuel tank is also low. As a result, ice may form inside the ejector and adhere to the ejector nozzle. By executing the pulse control mode, the controller can blow off the ice adhering to the nozzle. As a result, the flow rate of fuel gas supplied to the ejector can be ensured in the fuel cell system.

In a fourth aspect, in the third aspect, the first predetermined condition may further include that a current value of the fuel cell is less than a first predetermined value.

When the current value of the fuel cell is less than the first predetermined value, the amount of fuel gas supplied from the fuel tank to the ejector is relatively small. Therefore, ice adhering to the nozzle cannot be blown off. According to the above configuration, by executing the pulse control mode, the controller can blow off ice adhering to the nozzle. Therefore, in the fuel cell system, the flow rate of fuel gas supplied to the ejector can be ensured.

In a fifth aspect, in the fourth aspect, the first predetermined condition may further include that an elapsed time since completion of filling the fuel tank with the fuel gas exceeds a first predetermined time.

Immediately after the fuel tank is filled with fuel gas, the temperature of the fuel gas is relatively high due to compression work. According to the above configuration, it is possible to suppress the execution of the pulse control mode in a situation where the possibility of ice formation in the ejector is low. Therefore, the durability of the linear solenoid valve can be improved.

In a sixth aspect, in any one of the first aspect to fifth aspect, the controller may be configured to execute the pulse control mode when a second predetermined condition is satisfied. The second predetermined condition may include that a state under which a current value of the fuel cell is greater than or equal to a second predetermined value continues for a second predetermined time or longer.

When the situation where the amount of fuel gas supplied from the fuel tank to the ejector is relatively large continues, the temperature of the fuel gas temporarily decreases. In this case, ice forms in the ejector and adheres to the nozzle. According to the above configuration, the controller can blow off the ice adhering to the nozzle by executing the pulse control mode. As a result, the flow rate of fuel gas supplied to the ejector can be ensured in the fuel cell system.

### FIRST EMBODIMENT

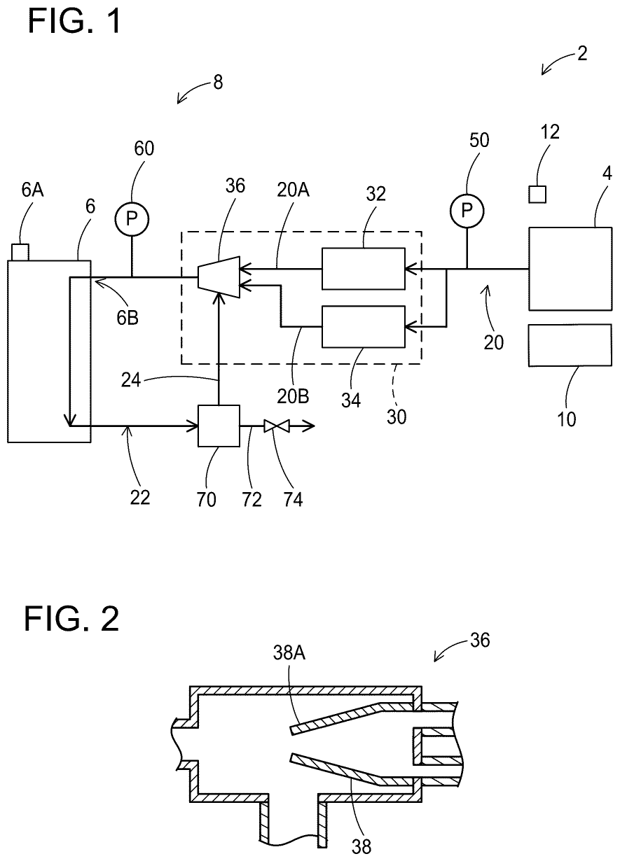

Referring to FIGS. 1 and 2, the fuel cell system 2 will be described. The application of the fuel cell system 2 is not particularly limited. For example, the fuel cell system 2 may be a fuel cell system for a movable body, such as a vehicle or a ship, or a stationary fuel cell system used in stationary power generation equipment.

The fuel cell system 2 includes a fuel tank 4, a fuel cell 6, a hydrogen circulation system 8 in which hydrogen gas circulates as fuel gas, an air supply system (not shown) that supplies air as an oxidizing agent gas, a controller 10, and an outside temperature sensor 12. The fuel gas is hydrogen gas. Although not shown, the fuel cell system 2 further includes a water-cooled cooling system configured to cool the fuel cell 6. Note that the fuel cell system 2 may instead include an air-cooled cooling system.

The fuel cell 6 is a device that generates electricity through chemical reaction between hydrogen and oxygen. When hydrogen and oxygen react chemically, water is produced. The fuel cell 6 is equipped with a current sensor 6A that detects the current value of the fuel cell 6. Hereinafter, the current value of the fuel cell 6 will be referred to as “FC current value.”

The hydrogen circulation system 8 includes a supply flow path 20, an exhaust flow path 22, and a circulation flow path 24. The supply flow path 20 connects the fuel tank 4 to the fuel cell 6. The supply flow path 20 is a flow path configured to supply fuel gas to a fuel gas inlet 6B of the fuel cell 6. The exhaust flow path 22 connects the fuel cell 6 to a gas-liquid separator 70 described below. The exhaust flow path 22 is a flow path configured to discharge water generated in the fuel cell 6 and exhaust gas discharged from the fuel cell 6. Hereinafter, the exhaust gas will be referred to as “fuel off-gas.” The circulation flow path 24 connects the gas-liquid separator 70 and the ejector 36 described below. The circulation flow path 24 is a flow path configured to supply the fuel off-gas to the ejector 36.

The fuel cell system 2 further includes an ejector unit 30. The ejector unit 30 includes a linear solenoid valve (LSV) 32, an injector 34, and an ejector 36. The LSV 32 and the injector 34 are arranged in parallel in the supply flow path 20. The LSV 32 and the injector 34 adjust the fuel gas supply flow rate to the fuel gas inlet 6B of the fuel cell 6. The ejector 36 is arranged downstream of the LSV 32 and the injector 34 in the supply flow path 20.

The LSV 32 is arranged on a first branch flow path 20A branching from the supply flow path 20. The LSV 32 regulates the flow rate of fuel gas passing through the LSV 32 in accordance with the opening degree of a plunger (not shown). The structure of LSV 32 is not particularly limited and may adopt the structure of a known linear solenoid valve. The first branch flow path 20A downstream of the LSV 32 is connected to the ejector 36.

The injector 34 is disposed on a second branch flow path 20B, which branches separately from the supply flow path 20 to the first branch flow path 20A. The injector 34 is opened and closed by a valve body (not shown) being driven at a predetermined drive cycle by electromagnetic driving force or the like. The fuel gas flow rate is regulated by the ratio of a time the valve body is open and closed (opening time/total time of opening and closing time, duty ratio). The structure of the injector 34 is not particularly limited, and a known injector 34 structure may be adopted. The second branch flow path 20B downstream of the injector 34 is connected to the ejector 36.

As shown in FIG. 2, the ejector 36 is equipped with a nozzle 38. The ejector 36 draws fuel off-gas from the circulation flow path 24 by an injection pressure of fuel gas from the nozzle 38. As a result, the fuel off-gas is mixed with the fuel gas injected from the nozzle 38 and supplied back to the fuel cell 6. Note that the ejector 36 may comprise multiple nozzles. Additionally, the fuel cell system 2 may comprise multiple ejectors 36.

A first pressure sensor 50 and a second pressure sensor 60 are disposed on the supply flow path 20. The first pressure sensor 50 is disposed upstream of the branching point of the first branch flow path 20A and the second branch flow path 20B. The first pressure sensor 50 detects the pressure in the flow path upstream of the LSV 32 and the injector 34.

The second pressure sensor 60 is disposed between the ejector 36 and the fuel gas inlet 6B of the fuel cell 6. The second pressure sensor 60 detects the pressure in the flow path downstream of the ejector 36.

The fuel cell system 2 further comprises the gas-liquid separator 70, an exhaust drain flow path 72, and an exhaust drain valve 74. The gas-liquid separator 70 is connected to the downstream end of the exhaust flow path 22, the upstream end of the circulation flow path 24, and the upstream end of the exhaust drain flow path 72. The exhaust drain valve 74 is disposed in the exhaust drain flow path 72. When the exhaust drain valve 74 is opened, water is discharged through the exhaust drain flow path 72. Additionally, the fuel off-gas from the gas-liquid separator 70 is also discharged along with water through the exhaust drain flow path 72.

The controller 10 is configured as a computer equipped with a processor and a memory such as RAM, ROM. The controller 10 controls the operation of each part of the fuel cell system 2 in accordance with a program stored in the ROM, for example.

The controller 10 is connected to the current sensor 6A, the outside temperature sensor 12, the first pressure sensor 50, and the second pressure sensor 60. The controller 10 determines the target flow rate to be supplied to the fuel cell 6 using information obtained from sensors 6A, 12, 50, 60, etc. The target flow rate is the sum of the tank supply flow rate supplied from the fuel tank 4 to the fuel cell 6 via the ejector 36 and a circulation flow rate supplied from the gas-liquid separator 70 to the fuel cell 6 via the ejector 36. In other words, the target flow rate can also be referred to as the flow rate to be supplied to the ejector 36.

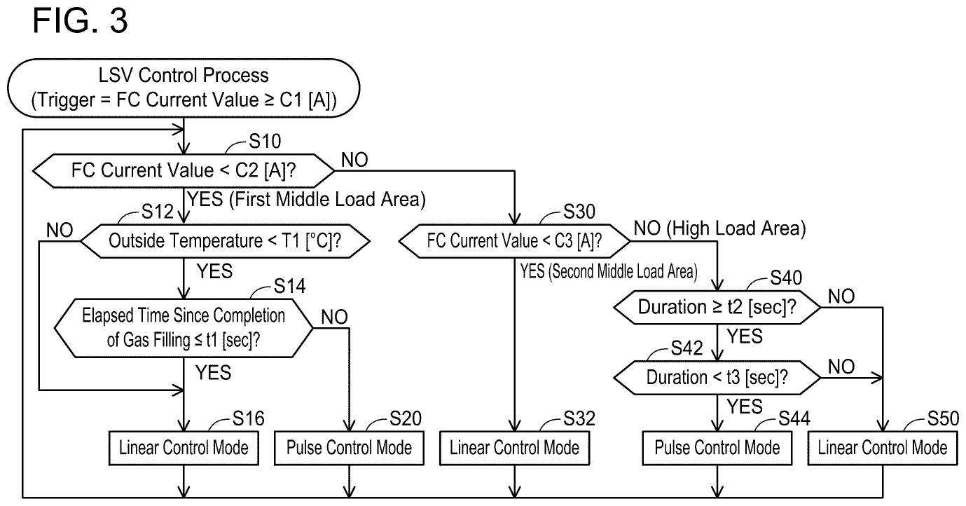

The controller 10 controls the operations of the LSV 32 and the injector 34 based on the FC current value detected by the current sensor 6A. The controller 10 achieves the target flow rate by operating the injector 34 when the FC current value is less than a first predetermined current value C1 [A]. Specifically, the controller 10 achieves the target flow rate by changing the current supplied to a coil of the injector 34 into pulse form. Furthermore, the controller 10 achieves the target flow rate by actuating the LSV 32 when the FC current value is equal to or greater than the first predetermined current value C1 [A]. The controller 10 controls the operation of the LSV 32 in accordance with an LSV control process shown in FIG. 3. Note that the controller 10 maintains the injector 34 in a fully open state when the FC current value is equal to or greater than the first predetermined current value C1 [A].

### LSV Control Process; FIG. 3

Referring to FIG. 3, the LSV control process executed by the controller 10 will be described. The LSV control process is a process for determining whether to operate the LSV 32 in the linear control mode or the pulse control mode. The controller 10 starts the processes shown in FIG. 3 when the FC current value is equal to or greater than the first predetermined current value C1 [A].

In S10, the controller 10 determines whether the FC current value is less than a second predetermined current value C2 [A]. The second predetermined current value C2 [A] is a value greater than the first predetermined current value C1 [A]. If the FC current value is less than the second predetermined current value C2 [A] (YES in S10), the controller 10 proceeds to S12. Contrary to this, when the FC current value is not less than the second predetermined current value C2 [A] (NO in S10), the controller 10 proceeds to S30.

In S12, the controller 10 determines whether the outside temperature is below a predetermined temperature T1 [° C.]. If the outside temperature is below the predetermined temperature T1 [° C.] (YES in S12), the controller 10 proceeds to S14. Contrary to this, when the controller 10 determines that the outside temperature is not below the predetermined temperature T1 [° C.] (NO in S12), the controller 10 proceeds to S16.

In S14, the controller 10 determines whether an elapsed time since completion of filling the fuel tank 4 with the fuel gas is less than or equal to a first predetermined time t1 [seconds]. If the elapsed time is less than or equal to the first predetermined time t1 [seconds] (YES in S14), the controller 10 proceeds to S16. Contrary to this, when the elapsed time is not less than the first predetermined time t1 [seconds], i.e., when the elapsed time exceeds the first predetermined time t1 [seconds] (S14: NO), the controller 10 proceeds to S20.

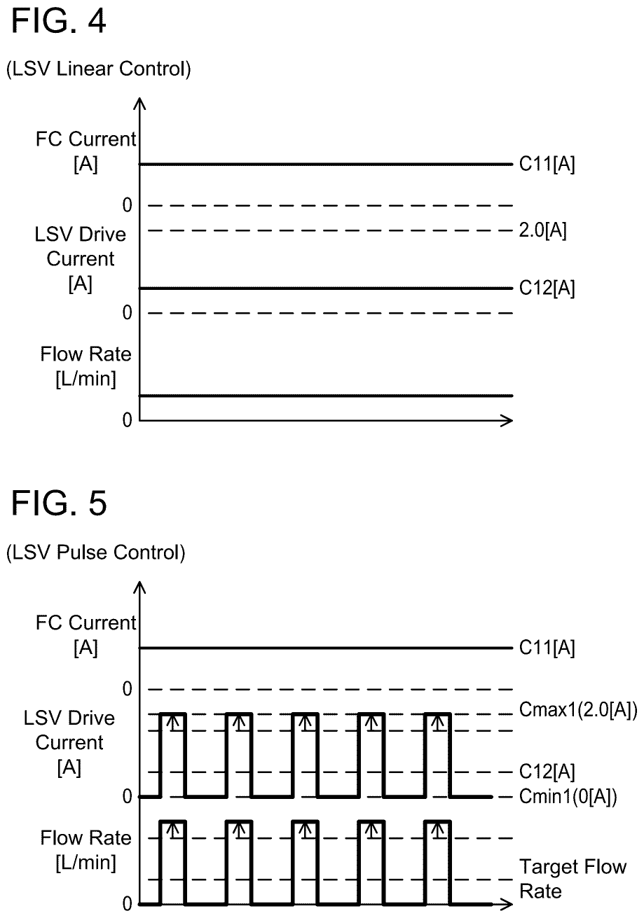

In S16, the controller 10 decides to operate the LSV 32 in the linear control mode. As shown in FIG. 4, the linear control mode is a mode that achieves the target flow rate by maintaining the opening degree of the LSV 32 at a constant value. A case where the FC current value is a current value C11 [A] will be described. In this case, the controller 10 determines the target flow rate corresponding to the current value C11 [A] and determines a current value C12 [A] as the drive current value of the LSV 32 corresponding to the determined target flow rate. Next, the controller 10 instructs the LSV 32 to set the current value to C12 [A]. As a result, the opening degree of the LSV 32 is maintained at the opening degree corresponding to the current value C12 [A]. Thus, the flow rate of fuel gas supplied from the fuel tank 4 and the gas-liquid separator 70 to the fuel cell 6 becomes the target flow rate. When S16 in FIG. 3 ends, the controller 10 returns to S10.

Furthermore, at S20 in FIG. 3, the controller 10 determines to operate the LSV 32 in pulse control mode. As shown in FIG. 5, the pulse control mode is a mode that achieves the target flow rate by periodically changing the opening degree of the LSV 32 between two values. The controller 10 periodically changes the drive current of the LSV 32 between a first minimum current value Cmin1 [A] and a first maximum current value Cmax1 [A]. The first minimum current value Cmin 1 [A] and the first maximum current value Cmax 1 [A] are 0 [A] and 2.0 [A], respectively. Furthermore, the first minimum current value Cmin1 [A] and the first maximum current value Cmax1 [A] correspond to a minimum opening degree and maximum opening degree of the LSV 32, respectively. A case where the FC current value is the current value C11 [A] will be described below. In this case, the controller 10 determines the target flow rate corresponding to the current value C11 [A]. Next, the controller 10 adds a predetermined flow rate to the target flow rate to determine a new target flow rate. Next, the controller 10 determines a control method for the drive current of the LSV 32 such that the average flow rate when the LSV drive current is periodically changed between the first minimum current value Cmin1 [A] and the first maximum current value Cmax1 [A] becomes the target flow rate. Specifically, the controller 10 determines the ratio of a time during which the drive current of the LSV 32 is set to the first minimum current value Cmin1 [A] and a time during which the drive current of the LSV 32 is set to the first maximum current value Cmax1 [A]. Next, the controller 10 controls the drive current of the LSV 32. As a result, the opening degree of LSV 32 is periodically changed between the minimum opening degree and the maximum opening degree. Then, the flow rate of fuel gas supplied from the fuel tank 4 and the gas-liquid separator 70 to the fuel cell 6 becomes the target flow rate. Thus, when the FC current value is the same, the target flow rate in the pulse control mode is greater than the target flow rate in the linear control mode. When S20 in FIG. 3 ends, the controller 10 returns to S10.

In S30, the controller 10 determines whether the FC current value is less than a third predetermined current value C3 [A]. The third predetermined current value C3 [A] is a value greater than the second predetermined current value C2 [A]. If the FC current value is less than the third predetermined current value C3 [A] (YES in S30), the controller 10 proceeds to S32. Contrary to this, when the FC current value is not less than the third predetermined current value C3[A] (NO in S30), the controller 10 proceeds to S40.

S32 is the same as S16. When S32 ends, the controller 10 returns to S10.

In S40, the controller 10 determines whether the duration of a state in which the FC current value is equal to or greater than the third predetermined current value C3[A] is equal to or longer than a second predetermined time t2[seconds]. If the duration is equal to or longer than the second predetermined time t2[seconds] (YES in S40), the controller 10 proceeds to S42. Contrary to this, when the duration is less than the second predetermined time t2 [seconds] (NO in S40), the controller 10 proceeds to S50.

In S42, the controller 10 determines whether the duration of a state in which the FC current value is equal to or greater than the third predetermined current value C3 [A] is less than a third predetermined time t3 [seconds]. The third predetermined time t3 [seconds] is a time longer than the second predetermined time t2 [seconds]. If the duration is less than the third predetermined time t3 [seconds] (YES in S42), the controller 10 proceeds to S44. Contrary to this, when the duration is not less than the third predetermined time t3 [seconds] (NO in S42), the controller 10 proceeds to S50.

S44 is the same as S20. When S44 ends, the controller 10 returns to S10.

S50 is the same as S20. When S50 ends, the controller 10 returns to S10.

Note that, when the FC current value falls below the first predetermined current value C1[A]while the processing shown in FIG. 3 is being executed, the controller 10 switches the LSV 32 to a fully closed state and ends the processing shown in FIG. 3.

In summary, the controller 10 operates the injector 34 in a low load area where the FC current value is less than the first predetermined current value C1[A]. Furthermore, the controller 10 operates the LSV 32 in either the linear control mode or the pulse control mode in a first medium load area where the FC current value is equal to or greater than the first predetermined current value C1[A] and less than the second predetermined current value C2[A]. Furthermore, the controller 10 operates the LSV 32 in the linear control mode in a second medium load area where the FC current value is equal to or greater than the second predetermined current value C2 [A] and less than the third predetermined current value C3 [A]. Also, the controller 10 operates the LSV 32 in either the linear control mode or the pulse control mode in a high load area where the FC current value is equal to or greater than the third predetermined current value C3[A].

Furthermore, the controller 10 executes the pulse control mode when either a first pulse control mode execution condition or a second pulse control mode execution condition is satisfied, and executes the linear control mode when neither a first pulse control mode execution condition nor a second pulse control mode execution condition is satisfied. The first pulse control mode execution condition is that the FC current value is less than the second predetermined current value C2 [A] (YES in S10 in FIG. 3), the outside temperature is below a predetermined temperature T1 [° C.] (YES in S12), and the elapsed time since completion of filling the fuel tank 4 with the fuel gas exceeds a first predetermined time t1 [seconds] (NO in S14). The second pulse control mode execution condition includes that the state where the FC current value is at or greater than the third predetermined current value C3 [A] continues for the second predetermined time t2 [sec] (YES in S30, YES in S40), and such duration is less than the third predetermined time t3 [sec] (YES in S42).

As described above, the fuel cell system 2 comprises the fuel cell 6, the fuel tank 4 configured to store fuel gas to be supplied to the fuel cell 6, and the supply flow path 20 comprising the LSV 32 and the ejector 36 disposed downstream of the LSV 32 and configured to supply fuel gas from the fuel tank 4 to the fuel cell 6 (example of “fuel gas supply path”), and the controller 10 configured to supply fuel gas at a target flow rate to the ejector 36 by controlling the operation of the LSV 32. The controller 10 is configured to execute the linear control mode (S16, S32, S50 in FIG. 3) of maintaining the opening degree of the LSV 32 at a constant value to achieve the target flow rate, and the pulse control mode (S20, S44 in FIG. 3) of periodically changing the opening degree of the LSV 32 between at least two values to achieve the target flow rate.

According to the above configuration, when the controller 10 executes the pulse control mode, ice adhering to the nozzle 38 can be blown off. As a result, the flow rate of fuel gas supplied to the ejector 36 can be ensured in the fuel cell system 2.

Furthermore, the controller 10 is configured to execute the pulse control mode when the first pulse control mode execution condition (example of “first predetermined condition”) is satisfied. The first pulse control mode execution condition includes at least that the outside temperature is below a predetermined temperature T1 [° C.] (YES in S12 in FIG. 3).

When the outside temperature is below the predetermined temperature T1 [° C.], the temperature of the fuel gas in the fuel tank 4 is also low. As a result, ice forms inside the ejector 36 and adheres to the nozzle 38 of the ejector 36. By executing the pulse control mode, the controller 10 can blow off the ice adhering to the nozzle 38. As a result, the flow rate of fuel gas supplied to the ejector 36 can be ensured in the fuel cell system 2.

Additionally, the first pulse control mode execution condition further includes that the FC current value is less than the second predetermined current value C2[A] (example of the “first predetermined value”) (YES in S10 in FIG. 3).

When the FC current value is less than the second predetermined current value C2[A], the amount of fuel gas supplied from the fuel tank 4 to the ejector 36 is relatively small. Therefore, ice adhering to the nozzle 38 cannot be blown off. According to the above configuration, by executing the pulse control mode, the controller 10 can blow off ice adhering to the nozzle 38. As a result, the flow rate of fuel gas supplied to the ejector 36 can be ensured in the fuel cell system 2.

Additionally, the first pulse control mode execution condition further includes that the elapsed time since completion of filling the fuel tank 4 with the fuel gas exceeds the first predetermined time t1 [seconds] (NO in S14).

Immediately after the fuel tank 4 is filled with fuel gas, the temperature of the fuel gas is relatively high due to compression work. According to the above configuration, it is possible to suppress the execution of the pulse control mode in a condition where the possibility of ice formation in the ejector 36 is low. Therefore, the durability of the LSV 32 can be improved.

Additionally, the controller 10 is configured to execute the pulse control mode when the second pulse control mode execution condition is satisfied. This includes that a state where the FC current value is equal to or greater than the third predetermined current value C3[A] (an example of the “second predetermined value”) continues for the second predetermined time t2 [seconds].

When the situation where the amount of fuel gas supplied from the fuel tank 4 to the ejector 36 is relatively large continues, the temperature of the fuel gas temporarily decreases. In this case, ice forms in the ejector 36 and adheres to the nozzle 38. According to the above configuration, the controller 10 can blow off the ice adhering to the nozzle 38 by executing the pulse control mode. As a result, the flow rate of fuel gas supplied to the ejector 36 can be ensured in the fuel cell system 2.

### SECOND EMBODIMENT

In the second embodiment, the pulse control mode of the LSV 32 in S20 and S44 in FIG. 3 is different from the pulse control mode of the LSV 32 in the first embodiment.

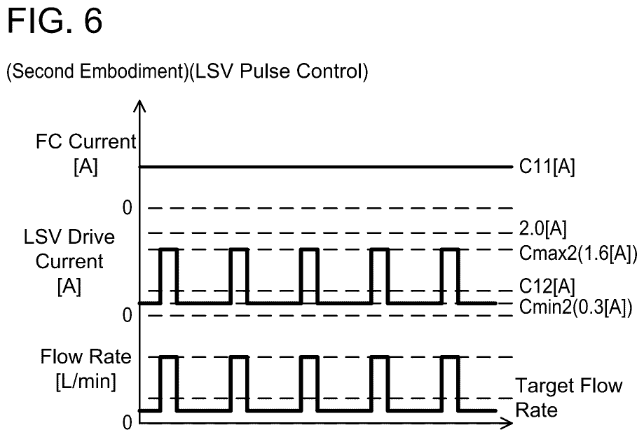

Referring to FIG. 6, the pulse control mode of the LSV 32 in the second embodiment will be described. The pulse control mode is a mode of achieving the target flow rate by periodically changing the opening degree of the LSV 32 between two values. The controller 10 periodically changes the drive current of the LSV 32 between a second minimum current value Cmin2 [A] and a second maximum current value Cmax2 [A]. The second minimum current value Cmin2 [A] is greater than zero and smaller than the current value required to achieve the target flow rate in the linear control mode. The second maximum current value Cmax2 [A] is greater than the current value required to achieve the target flow rate in the linear control mode and smaller than the current value corresponding to the maximum opening degree of the LSV 32.

This section will describe a case where the FC current value is C11 [A]. In this case, the controller 10 determines the target flow rate corresponding to a current value C11 [A]. Next, the controller 10 determines the control method for the drive current of the LSV 32 such that the average flow rate when the LSV drive current is periodically changed between the second minimum current value Cmin2 [A] and the second maximum current value Cmax2 [A] becomes the target flow rate. Specifically, the controller 10 determines the ratio of a time during which the drive current of the LSV 32 is set to the second minimum current value Cmin2 [A] and a time during which the drive current of the LSV 32 is set to the second maximum current value Cmax2 [A]. Next, the controller 10 controls the drive current of the LSV 32. As a result, the opening degree of the LSV 32 is changed between the opening degree corresponding to the second minimum current value Cmin2[A] and the opening degree corresponding to the second maximum current value Cmax2[A]. Then, the flow rate of fuel gas supplied from the fuel tank 4 and the gas-liquid separator 70 to the fuel cell 6 becomes the target flow rate. In this way, in this embodiment, when the FC current values are the same, the target flow rate in the pulse control mode is the same as the target flow rate in the linear control mode.

As described above, in the pulse control mode, the opening degree of the LSV 32 is periodically changed between at least two values that are not zero.

When the opening degree of the LSV 32 is periodically changed between at least two values including zero, the valve body of the LSV 32 seats on the valve seat of the solenoid valve each time the opening degree of the LSV 32 becomes zero. According to the above configuration, in the pulse control mode, the valve body does not seat on the valve seat. Therefore, the durability of LSV 32 can be improved.

The embodiments have been described in detail above. However, these are only examples and do not limit the claims. The technology described in the claims includes various modifications and changes of the concrete examples represented above.

(First Modification) The fuel cell system 2 may not comprise the injector 34. In this modification, the controller 10 executes S12 to S20 in FIG. 3 even when the FC current value is less than the first predetermined current value C1 [A].

(Second Modification) The controller 10 may achieve the target flow rate by periodically changing the opening degree of the LSV 32 between three or more values in the pulse control mode.

(Third Modification) S10 to S16 and S20 in FIG. 3 may be omitted.

(Fourth Modification) S12, S14, and S16 in FIG. 3 may be omitted. In this modification, the controller 10 executes the pulse control mode when the FC current value is less than the second predetermined current value C2 [A].

(Fifth Modification) The controller 10 may be configured to execute the pulse control mode when the outside temperature is below a predetermined temperature T [° C.], regardless of the FC current value.

(Sixth Modification) S14 in FIG. 3 may be omitted. In this modification, the controller 10 executes the pulse control mode when the determination in YES is determined in S10 and S12.

(Seventh Modification) S30, S40 to S44, and S50 in FIG. 3 may be omitted. In this modification, the controller 10 executes the linear control mode when NO is determined in S10.

(Eighth Modification) The controller 10 may be configured to execute both the pulse control mode of the first embodiment and the pulse control mode of the second embodiment. As an example, the controller 10 may execute the pulse control mode according to the second embodiment when the elapsed time since startup is less than a predetermined time, and execute the pulse control mode according to the first embodiment when the elapsed time exceeds the predetermined time.

The technical elements explained in the present description or drawings exert technical utility independently or in combination of some of them, and the combination is not limited to one described in the claims as filed. Moreover, the technology exemplified in the present description or drawings achieves a plurality of objects at the same time, and has technical utility by achieving one of such objects.

What is claimed is

1. A fuel cell system comprising:
a fuel cell;
a fuel tank configured to store fuel gas to be supplied to the fuel cell;
a fuel gas supply path comprising a linear solenoid valve and an ejector disposed downstream of the linear solenoid valve, the fuel gas supply path being configured to supply the fuel gas from the fuel tank to the fuel cell; and
a controller configured to supply the fuel gas to the ejector at a target flow rate by controlling operation of the linear solenoid valve,
wherein the controller is configured to execute a linear control mode and a pulse control mode selectively,
wherein in the linear control mode, the controller is configured to achieve the target flow rate by maintaining a constant opening degree of the linear solenoid valve, and
in the pulse control mode, the controller is configured to achieve the target flow rate by periodically changing the opening degree of the linear solenoid valve between at least two values.

2. The fuel cell system as in claim 1, wherein, in the pulse control mode, the opening degree of the linear solenoid valve is periodically changed between the at least two values that are not zero.

3. The fuel cell system as in claim 1, wherein the controller is configured to execute the pulse control mode when a first predetermined condition is satisfied, and
the first predetermined condition includes, at least, that an outside temperature is below a predetermined temperature.

4. The fuel cell system as in claim 3, wherein the first predetermined condition further includes that a current value of the fuel cell is less than a first predetermined value.

5. The fuel cell system as in claim 4, wherein the first predetermined condition further includes that an elapsed time since completion of filling the fuel tank with the fuel gas exceeds a first predetermined time.

6. The fuel cell system as in claim 1, wherein the controller is configured to execute the pulse control mode when a second predetermined condition is satisfied, and
the second predetermined condition includes that a state under which a current value of the fuel cell is greater than or equal to a second predetermined value continues for a second predetermined time or longer.
